(19) United States
(12) Patent Application Publication
(10) Pub. No.: US 2009/0327915 A1
(43) Pub. Date: Dec. 31, 2009

(54) Automatic GUI Reconfiguration Based On User Preferences

(75) Inventors: Kevan D. Holdaway, Hillsborough, NC (US); Ivan R. Olguin, II, Tucson, AZ (US); Nedzad Taljanovic, Tucson, AZ (US)

Correspondence Address: QUARLES & BRADY LLP, ONE SOUTH CHURCH AVENUE, SUITE 1700, TUCSON, AZ, 85701, US

(73) Assignee: INTERNATIONAL BUSINESS MACHINES CORPORATION, Armonk, NY (US)

(21) Appl. No.: 12/163,860

(22) Filed: Jun. 27, 2008

(51) Int. Cl. G06F 3/00; G06F 17/30

(52) U.S. Cl. 715/745; 707/1; 707/E17.001

(57) ABSTRACT

Systems and methods for configuring a graphical user interface on the basis of user preferences are disclosed. The systems and methods aggregate elementary user interactions with a graphical user interface into higher level actions on the basis of temporal markings and thresholds.

### FIELD OF THE INVENTION

This invention relates to systems and methods for reconfiguration of graphical user interfaces based on the preferences and prior activity of specific users.

### BACKGROUND OF THE INVENTION

The graphical user interface (GUI) is the dominant method used to provide human-machine interaction for nearly all types of computing devices. At its most basic level, a GUI represents applications, tasks, available data storage and/or data objects such as files to a computer user as graphical icons on a display. A user can then interact with the applications and/or data by manipulating the icon, for example by clicking on or dragging it to another part of the display.

Graphical user interfaces have conventionally been static or hard coded to allow a user to perform a specific set of tasks in a specific order. For example, when a personal computer arrives at the “desktop” level screen after an initial startup, the user sees a largely static array of icons representing applications and/or files. Different icons representing other applications and/or files can be added to or removed from the desktop, but such modification requires action by the user. Users can perform limited customization by selecting among a number of “wizards” with common options that attempt to simplify or direct the actions that a user performs. The only widespread conventional alternative is to make all reconfigurations manually.

### SUMMARY OF THE INVENTION

The invention provides systems and methods for automatically configuring a GUI by capturing previous user actions in the GUI. Systems and methods according to the invention track user actions with an action tracking process, such as a back-end Servlet that records various level of actions. These actions are stored and associated with a user profile corresponding to a particular user or group of users. When a user attempts to repeat an action, the user is presented with an updated GUI reflecting the customization performed the last time the user performed the action. Actions are also grouped into higher level tasks when many actions are executed in close proximity in time to one another.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing the components of a networked computing environment according to the invention;

FIG. 2 is a block diagram showing the modular components of an automatic GUI configuration system according to the invention;

FIG. 3 is a flow chart summarizing the steps performed by an embodiment of the invention in order to capture user preferences;

FIG. 3a is a flow chart summarizing the steps performed by an embodiment of the invention in order to capture user preferences;

FIG. 3b is a flow chart summarizing the steps performed by an embodiment of the invention in order to capture user preferences;

FIG. 4 is a flow chart summarizing the steps performed by an embodiment of the invention in order to automatically reconfigure a GUI;

FIG. 5 is a block diagram showing a data structure reflecting user preferences according to the invention.

### DETAILED DESCRIPTION OF THE PREFERRED EMBODIMENTS

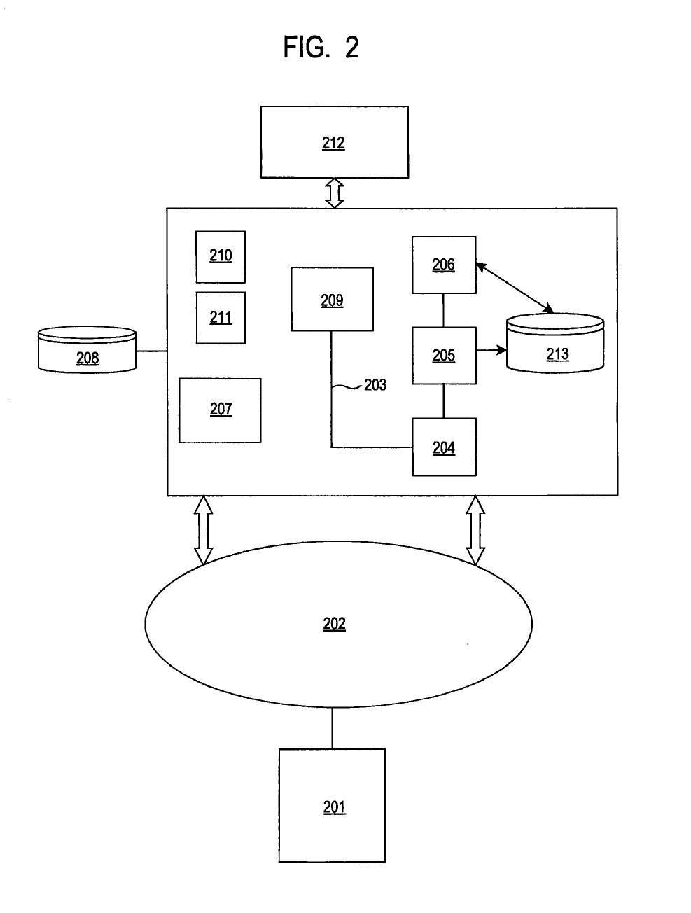

Many of the functional units described in this specification have been labeled as modules (e.g., modules 204-211, FIG. 2) in order to more particularly emphasize their implementation independence. A module (e.g., modules 204-211, FIG. 2) may be implemented as a hardware circuit comprising custom VLSI circuits or gate arrays, off-the-shelf semiconductors such as logic chips, transistors, or other discrete components. A module (e.g., modules 204-211, FIG. 2) may also be implemented in programmable hardware devices such as field programmable gate arrays, programmable array logic, programmable logic devices, or the like.

Modules (e.g., modules 204-211, FIG. 2) may also be implemented in software for execution by various types of processors. An identified module of executable code may, for instance, comprise one or more physical or logical blocks of computer instructions which may, for instance, be organized as an object, procedure, or function. Such functional blocks may be described generally as “logic”. Nevertheless, the executables of an identified module (e.g., modules 204-211, FIG. 2) need not be physically located together, but may comprise disparate instructions stored in different locations which, when joined logically together, comprise the module and achieve the stated purpose for the module.

Indeed, a module of executable code (e.g., modules 204-211, FIG. 2) may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

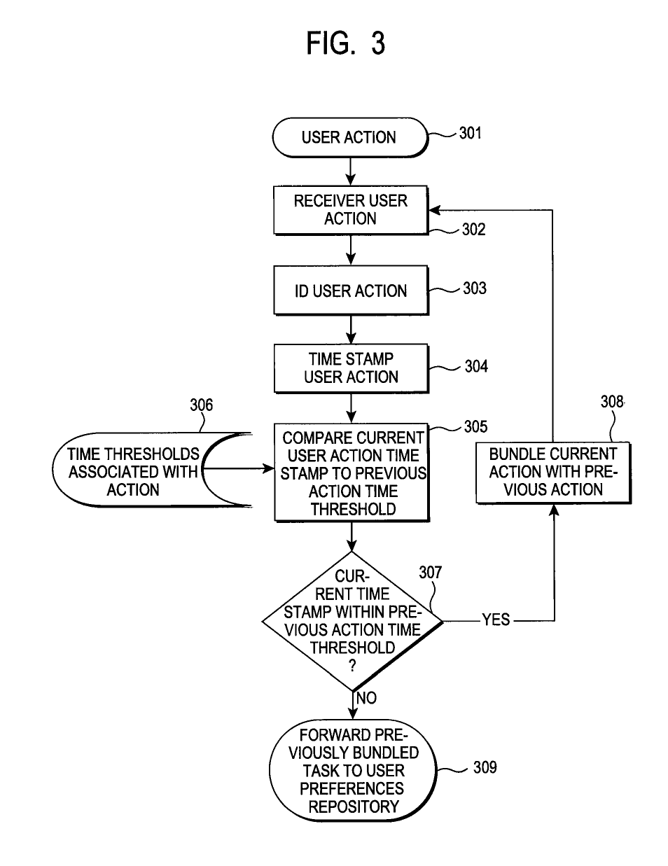

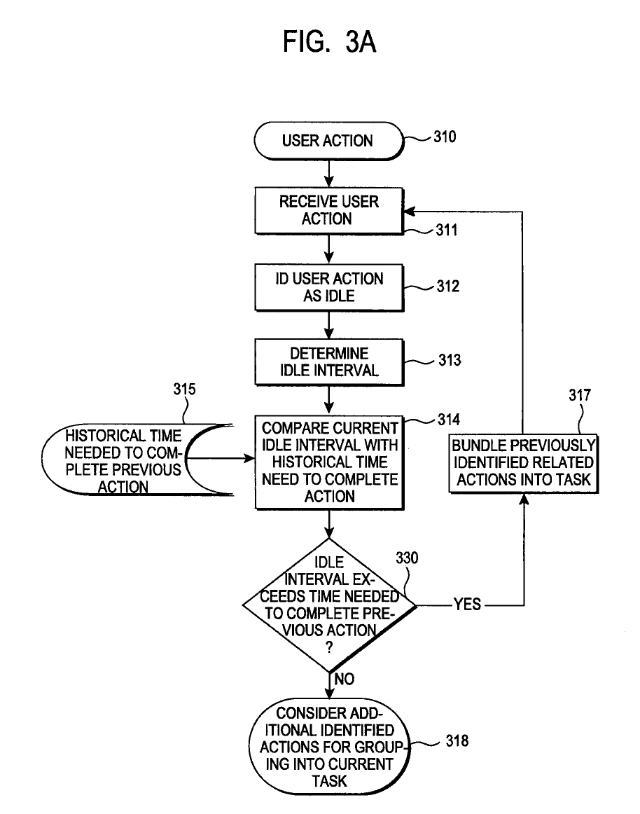

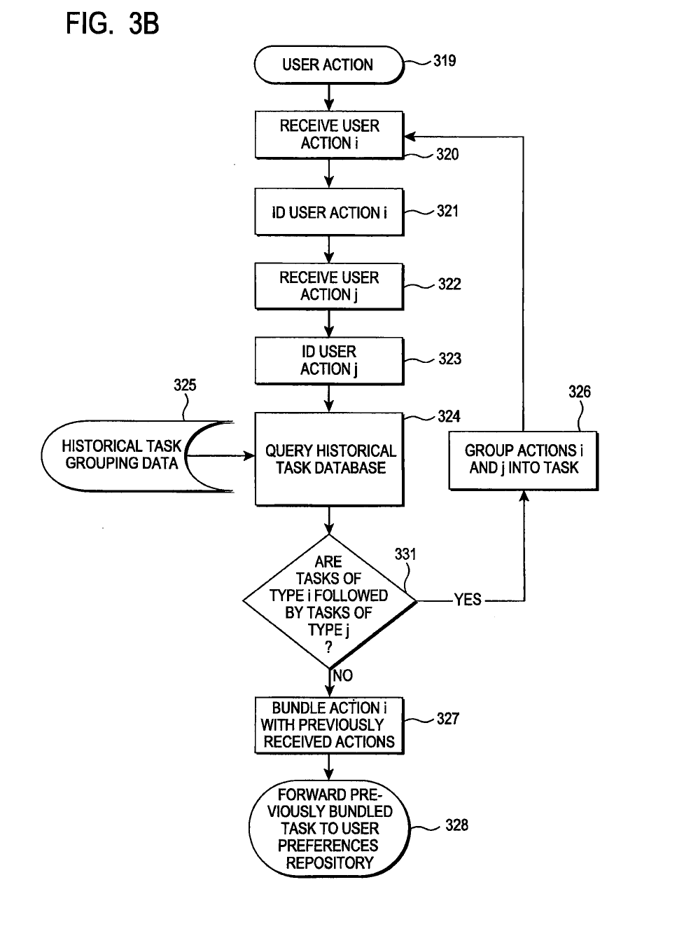

The schematic flow chart diagrams included are generally set forth as logical flow-chart diagrams (e.g., FIGS. 3, 3a, 3b). As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method (e.g., FIGS. 3, 3a, 3b). Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Moreover, steps may be combined or omitted without taking a particular embodiment out of the scope of the invention.

The described operations may be implemented as a method, apparatus or article of manufacture using standard programming and/or engineering techniques to produce software, firmware, hardware, or any combination thereof. The described operations may be implemented as code maintained in a “computer readable medium”, where a processor may read and execute the code from the computer readable medium.

A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc.

The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices.

An “article of manufacture” or “computer program product” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The invention disclosed herein is based on systems and methods for automatically reconfiguring a GUI on the basis of previous user interactions. The invention may be implemented as a method, instructions disposed on a computer readable medium for carrying out a method, apparatus or article of manufacture using standard programming or engineering techniques to produce software, firmware, hardware, or any combination thereof. The term “system” as used herein may refer to code or logic implemented in hardware or computer readable media such as optical storage devices, and volatile or non-volatile memory devices. Such hardware may include, but is not limited to, field programmable gate arrays (“FPGAs”), application specific integrated circuits (“ASICs”), complex programmable logic devices (“CPLDs”), programmable logic arrays (“PLAs”), microprocessors, or other similar processing devices.

This invention is described in preferred embodiments in the following description with reference to the Figures, in which like numbers represent the same or similar elements.

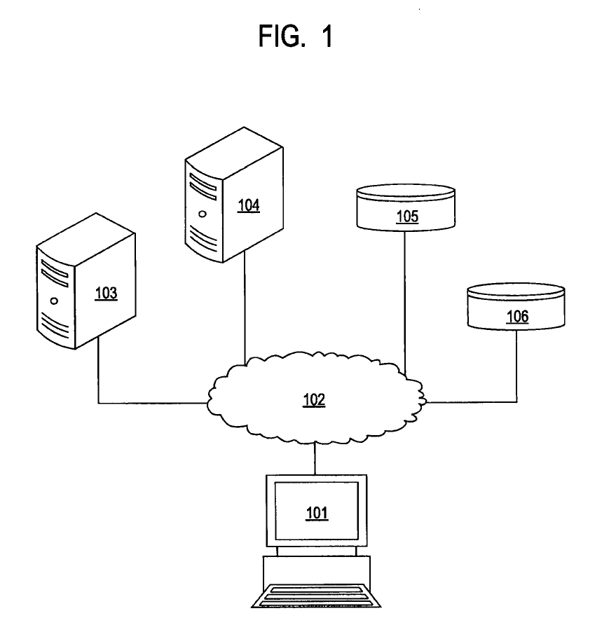

Referring to FIG. 1, a user 101 is connected to a network 102. The user may be an individual computer user, a group of users, or an automated application or process. The user may interface with the network through one or more client computers, not shown. The network 102 may be a local area, wide area or global network such as the Internet. Through the network 102, the user 101 has access to a plurality of network resources that can include networked servers 103, 104 and/or networked storage devices 105, 106. The networked servers 103, 104 also have access to the networked storage devices and one another through the network 102. Networked servers 103, 104 include applications executable by the user 101 through the network 102.

In certain embodiments, servers 103, 104 comprise a computer systems, such as a mainframe computer, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; and UNIX is a registered trademark in the United States and other countries licensed exclusively through The Open Group.)

Referring to FIG. 2, a user 201 interacts with a GUI 202. The GUI 202 can be generated by a user 201's client computer, or can be generated remotely, for example, by a network application in communication with a user 201. An example of a GUI 202 would be the display of a web page by an internet browser. Exemplary interactions with the web page GUI include launching applications or requesting new pages to be displayed.

The GUI 202 provides the interface between the user 201 and one or more applications 212. GUI 202 is in communication with a GUI configuration application 203 that is interposed between the GUI 202 and one or more applications 212. The GUI configuration application 203 includes a user feedback tracking module 204, a feedback analyzer 205, a task compiler 206 and a GUI rendering module 207. The feedback tracking module 204 receives feedback from the GUI 202 reflecting interactions that the user has with the GUI 202. In the example of the webpage set forth above, the feedback tracking module 204 receives reports from the GUI 202 whenever the user takes an interactive action with the GUI. Examples, of actions that might be taken by the user and tracked by the feedback tracking module 204 include clicking on an active area of a page, hovering a cursor over a particular area, idle time of a mouse cursor (i.e., the absence of any user action can be tracked as a user action), requesting a new page, viewing the properties of a page or a device managed by the page, highlighting text on a page, typing text into an area on the page, or any other action in conjunction with some input device. In one implementation, the feedback tracking module 204 is implemented as a Servlet that receives XML messages from the user reflecting user interactions with the GUI 202. In some embodiments, the feedback tracking module 204 is multi-threaded to receive input from multiple sources, for example, the interactions of multiple users with their respective GUIs or multiple applications on a particular user's computer reflecting different kinds of user interactions.

The feedback tracking module 204 passes data regarding the user's interaction with the GUI 202 to the feedback analyzer 205. The feedback analyzer 205 takes raw data from the feedback tracking module 204, identifies the action according to its type and aggregates it into logical patterns of user interaction by determining logical relations between individual actions performed by the user 201. The result of the aggregation process performed by the feedback analyzer 205 is a record of the stand-alone actions performed by the user, for example, a record of the user loading a page that displays particular data or launching a particular application. The feedback analyzer 205 also associates a time stamp and/or time interval with each action.

After stand-alone actions have been identified and time stamped by the feedback analyzer, they are passed to the task compiler 206. The task compiler groups actions identified by the feedback analyzer 205 into tasks. A task is a higher-level, more complex procedure that may involve several related subsidiary actions. Actions are grouped into tasks on the basis of the temporal markings of the actions supplied by the feedback analyzer 205 and/or logical relations between the tasks. When grouping actions into a task, the task compiler 206 uses variable user set or automatically generated time thresholds to determine whether individual actions should be bundled together into a task. A variable temporal window for action grouping is useful because different individual actions can require different amounts of time to complete. If the user is involved in an action that is not typically time intensive, a small threshold can be applied, which would tend to disqualify actions that occur distantly in time from being grouped with the first action. On the other hand, if the user is involved in a time-intensive action, a large threshold can be applied which allows other actions that occur more distantly in time to be candidates for grouping into the same task.

Automatic GUI configuration system includes an historical task database 213 in communication with the feedback analyzer 205 and the task compiler 206. Historical task database 213 comprises a table of frequently encountered individual actions and typical times required by the system to complete those actions. Historical task database 213 also contains a list of actions that are typically logically related to one another as common tasks. For example, in the data storage management context, historical task database 213 may contain data showing that users typically follow a common sequence of creating storage pools, creating storage volume and creating mapping relationships between storage pools and storage volumes. The historical task database 213 is represented herein as a singular database in communication with the feedback analyzer 205 and the task compiler 206, however other database structures are acceptable. For example, the functions of historical task database 213 can be divided into two databases, a first database including information regarding common logical relations between common actions, and a second database including information regarding the time necessary to perform common actions.

Alternatively or additionally, actions are grouped into tasks on the basis of historical patterns of grouping. For example, when feedback analyzer 205 identifies a pair of actions, task compiler 206 queries the historical task database 213 to determine whether actions of the same type as the pair of actions under consideration have been grouped together into a task in the past. If a record of such a task definition exists, task compiler 206 can repeat the grouping with the actions under consideration.

The task compiler 206 can use the historic task database 213 to intelligently apply variable time thresholds to candidate user actions in order to accurately group actions into tasks. For example, task compiler 206 can access the historical task database's 213 a table of frequently encountered individual actions and typical times required by the system to complete those actions. Since a user might be expected to be idle during the typical amount of time needed to complete a given action, the task compiler 206, would apply a time threshold that is longer than the time needed to complete the action under consideration, to determine whether subsequent actions that are identified should be grouped with the current action under consideration. In certain embodiments of the invention, the feedback analyzer 205 updates the historical task database 213 with the actual times users require to perform certain actions. In certain embodiments, data processing such as averaging can be applied to the values stored in the historical task database 213, so that over time, systems according to the invention learn how long users take to perform certain tasks.

Variable time thresholds can be applied by the task compiler 206 in other ways. Task compiler 206 can expand or contract time thresholds in response to events that occur on the system that are not user initiated. For example, system errors that interrupt processes can be recognized by the task compiler 206, and in response to such events, the task compiler 206 could expand the time threshold being applied to an action under consideration. This would allow the task compiler 206 to wait until all processes are back on line so that a next action can be taken by a user can be considered for grouping when the next action occurs. Additionally or alternatively, expanded time thresholds could be applied to capture next actions that are delayed by lengthy, but fully functional, system processes.

Additionally or alternatively, embodiments of the invention apply variable time thresholds on the basis of user idle time. As is set forth above, the feedback tracking module 204 collects data regarding user idle time as well as individual user actions. For example, the feedback tracking module 205 observes that a mouse cursor or a keyboard is not in use. Feedback analyzer 205 associates a time value with the idle interval observed by the feedback tracking module 204.

The task compiler 206 can use user idle time in a number of ways. A long user idle time may indicate that the user has completed a discrete task, and is moving on to something else, or is taking a break or reviewing results. Accordingly, in certain embodiments, the task compiler 206 closes the set of actions under consideration for grouping into a task when it encounters a long user idle time, since a long idle time is likely to signal a division point between discrete tasks. The decision to close the set of actions under consideration for grouping into a task can be made when the user idle time exceeds some predefined or automatically generated threshold. Alternatively or additionally, a long idle time can be used by the feedback analyzer to adjust the values stored in the historical task database 213 to include, for example, reviewing results produced by launching a view with the time required to perform the action of launching the view.

Alternatively, a long idle-time might simply reflect that a given action takes a long time by the system to complete. In such a case, subsequent actions should still be considered for grouping with the long-running task, despite a long user idle time associated with the long-running task. In order to determine whether a given action falls into this category, systems of according to embodiments of the invention cause the task compiler 206 to query the historical task database 213 and compare the historical time required to complete a certain action with the value of the idle interval generated by the feedback analyzer 205. If the idle time is within the expected time required to complete an action, the set of actions considered for grouping into a task is kept open.

Feedback tracking module 204, feedback analyzer 205 and task compiler 206 also optionally gather data regarding application defined tasks. For example, many applications include “wizards” that guide a user through complex tasks. In the event that a user runs user repeatedly runs certain wizards in sequence, embodiments of the invention define new tasks, or meta-wizards that include all of the steps of the individually accessed wizards.

When the task compiler 206 has identified tasks, the tasks are stored in a user preferences repository 208. The user preference repository 208 is a database that associates preferences with a user. The user preference repository also optionally stores statistics on user preferences across users. For example, the user preference repository can store the most popular tasks performed by all users or a select group of users.

Alternatively or additionally, when the task compiler 206 has identified a task, a record of the task identification is stored in the historical task database 213 for future reference by the task compiler. In certain embodiments the historical task database 213 can associate a weight value with a given task definition that indicates the frequency with which the task compiler 206 has grouped particular types of actions into a task. The weight of historically defined tasks can be increased or decreased, either automatically or manually by the user or an administrator, to reflect the desirability or accuracy of a task definition. In this way, the task compiler 206 can be trained over time to recognize frequently encountered clusters of actions and group them into tasks.

GUI configuration application 203 includes an information view tracking module 209. Information view tracking module is implemented either as a separate process in communication with the user feedback tracking module 204, as shown in FIG. 2, or is a sub-process within the user feedback tracking module 204. Information view tracking module 209 maintains a record of the information views called up by the user 201, for example, by monitoring the information displayed by the GUI 202 in response to user actions. Examples of information views include screens displayed by application 212 when the user selections the applications “view” command. In the data storage management context, an exemplary information view is a screen showing the available storage space on a disk or array of disks. Information view tracking module 209 optionally associates time information with records of information views. Time information optionally includes the time a user calls up an information view and/or the duration during which an information screen is left on a user's display before being closed. The records generated by the information view tracking module are stored in the user preferences repository 208.

GUI configuration application 203 also optionally includes a user display preferences tracking module 211. The user display preferences tracking module 211 receives input from the user feedback tracking module 204. The user display preferences tracking module 211 generates a record of changes made to non-informational characteristics of the GUI display generated by application 212. Examples of non-informational display characteristics include font preferences, background colors, and the appearance of icons representing data objections or tasks or processes within application 212. The record generated by the user display preferences tracking module is stored in the user preferences repository 208.

GUI configuration application 203 also optionally includes an error message tracking module 210. The error message tracking module 210 receives input from the user feedback tracking module 204 and the application 212. Error message tracking module 210 maintains a record of error messages forwarded by applications being run by the user 201 to the GUI 202. In certain embodiments, error message tracking module 210 time stamps the error message record and maintains a count of the number of times a particular error message has been received by the user as part of the error message record. The records generated by the error message tracking module 210 are stored in the user preferences repository 208.

The GUI configuration application 203 also optionally includes a GUI rendering module 207. The GUI rendering module 207 communicates with the GUI 202 in order to reconfigure the GUI to make it more helpful to the user. The GUI rendering module 207 receives requests from the GUI 202 to display a page, or alternatively, display commands from the application 212 to display a page. The GUI rendering module 207 queries the user preferences repository 208 and customizes the GUI 202 to meet the user's preferences, for example, by displaying a page containing only links reflecting the tasks previously performed by the user, by displaying screens to the user incorporating the user's display preferences, and/or by providing frequently accessed information views displayed with the more accessed views displayed more prominently than the less frequently accessed views. The output of the GUI rendering module 207 can be thought of as a second GUI, which is a modification of a first default GUI that would be generated by the application 212 in the absence of the GUI configuration application 203.

Exemplary embodiments of invention render a GUI according to user preferences in a variety of other ways. For example, upon start-up, a user may check the properties of several devices. In the context of storage device management, for example, a user might check the properties of one or more storage devices to determine the amount of free storage space available in those devices. In this circumstance, feedback analyzer 205 records multiple “properties check” events in close proximity to one another and time, and the task compiler 206 identifies the task of checking properties on a set of storage devices. This defined task is stored in the user preference repository 208 and associated with the particular user. Upon startup, the GUI rendering module 207 automatically presents the user with a view showing the frequently viewed properties of frequently checked devices. Alternatively, the GUI rendering module 207 presents the user with a link to a customized task that includes viewing the properties of previously viewed devices.

Some applications include default nested drop-down menus of actions, for example, an “options” drop down menu, with an “advanced options” link within the “options” drop down menu, where the “advanced options” link provides still more views or actions. In the event that a user consistently navigates to the “advanced options” menu, The GUI rendering module 207, based on data collected by the information view tracking module 209, can more prominently display the “advanced options” tap, or display only advanced options instead of the general options menu.

The components, for example the various modules making up the GUI configuration application 203 and the user preferences repository 208 may be physically located together or separately anywhere so long as they are in electronic communication with a user's GUI 202. For example, in a network context, the user feedback tracking module 204, feedback analyzer 205, task compiler 206 and GUI rendering module 207 may be located on a GUI configuration server and the user preference repository 208 may be located on a portion of networked disk drive.

Referring to FIG. 3, a flowchart showing exemplary steps taken by a system implementing an embodiment of the invention to generate user preferences is shown. The user preferences storage procedure is initiated by a user action 301. As is set forth above with regard to FIG. 2, a user action is a simple interaction between the user and a GUI, for example, a mouse click. The system receives the user action 302, for example through the user feedback tracking module 204 described in relation to FIG. 2. The system then identifies the type of user action 303 and time stamps the user action 304. These steps are performed, for example, by the feedback analyzer 205 described in relation to FIG. 2. Once an action has been received, identified and time stamped, the action's timestamp is compared 305 to a time threshold associated with a previously received action 306. The time threshold associated with a previously received action 306 can be generated in accordance with data stored, for example, in the historical task database 213 described above with reference to FIG. 2, which includes a record of the amount of time a given type of action takes to complete. This comparison step is performed, for example, by the task compiler 206 described in relation to FIG. 2. If the current action's time stamp is within the threshold defined by a previously received action 306, the system bundles the current action with the previously received action for aggregation into a higher level task 308. The system then receives the next action. If the current action's time stamp is not within the threshold defined by a previously received action 306, the system assumes that the current action is part of a new task, and the previously bundled task is forwarded 309 to a user preferences repository, for example, the user preferences repository 208 described in relation to FIG. 2.

Referring to FIG. 3a, a flowchart including exemplary steps taken by a system implementing an embodiment of the invention to generate user preferences in response to a long user idle time is shown. A user initiates the exemplary process of FIG. 3a by performing a user action 310, which is collected and identified, for example by a user feedback tracking module 204 and feedback analyzer 205 described above in reference to FIG. 2. The system receives the user action 311, and identifies the user action as user idle 312. The system then determines the idle interval 313. The idle interval 313 is then compared 314 to the historical time needed to complete the action that was identified by the system immediately prior to the idle period 315. The system then performs a decision step 330 whereby the system evaluates the comparison of the idle interval 313 to the historical time needed to complete the action that was identified by the system immediately prior to the idle period 315. If the idle interval 313 exceeds the historical time needed to complete the action that was identified by the system immediately prior to the idle period 315, the set of actions under consideration for grouping into a task is closed, and previously identified actions are bundled into a task 317. If the idle interval does not exceed the historical time needed to complete the action that was identified by the system immediately prior to the idle period 315, the system continues to consider actions to be identified in the future for bundling with a previously identified action 318.

Referring to FIG. 3b, a flowchart including exemplary steps taken by a system implementing an embodiment of the invention to generate user preferences in response to the historic grouping of similar actions is shown. A user initiates the exemplary process of FIG. 3a by performing a user action 319, which is collected and identified, for example by a user feedback tracking module 204 and feedback analyzer 205 described above in reference to FIG. 2. The system receives a first user action i 320, and identifies the first user action i 321. The system receives a second user action j 322 and identifies the second user action j 323. The system queries a database containing historical task grouping data 325. The database containing historical task grouping data 325 is, for example, included in the historical task database 213 described above in reference to FIG. 2. On the basis of the historical task grouping data 325, the system determines 331 whether actions of the same type as action i are historically grouped with actions of the same type as action j. If historically, actions of types i and j are grouped, the system groups actions i and j into a task 326. If historically, actions of types i and j are not grouped, the system bundles action i with previously received actions 327 and forwards the previously bundled task to the User Preferences Repository 328. If action j is not grouped with action i, the system considers subsequently received actions for grouping with action j.

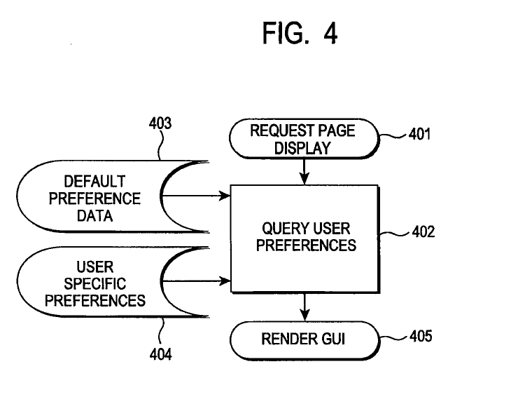

FIG. 4 shows a flowchart including the steps taken by an embodiment of the invention for reconfiguring a GUI on the basis of user preferences. A user initiates the GUI rendering process by requesting a page to display 401. The system queries the user preference repository 402, for example the user preference repository 208 described in relation to FIG. 2. The user preference repository has access to default preference data 403 and user specific preferences 404. The default preference data 403 includes GUI rendering instructions to be executed in the absence of any user specific preferences. The user specific preferences 404 include GUI rendering instructions based on high level tasks built from individual actions according to, for example, the process described above with regard to FIG. 3. Once the user preferences have been queried, the system renders the GUI 405 in accordance with user preferences.

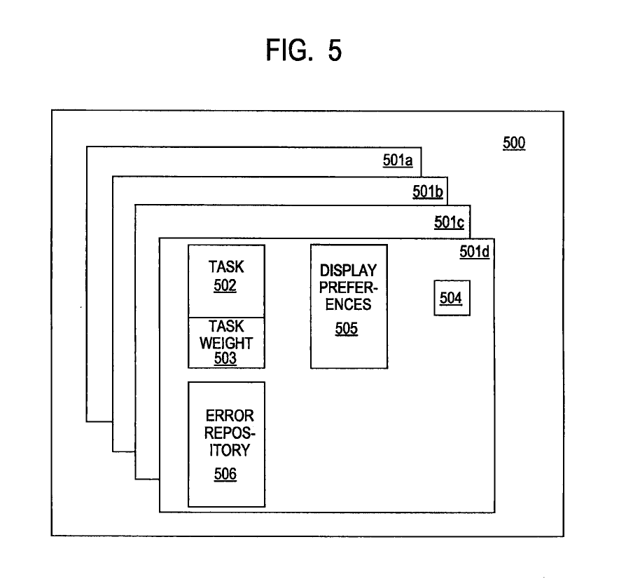

FIG. 5 shows the contents of a user preferences repository, for example user preferences repository 208 described above with respect to FIG. 2, according to the invention. The user preferences repository is implemented on a relational or non-relational database 500 implemented according to any suitable database management application running in connection with any suitable data storage device. Database 500 includes one or more data structures 501a, 501b, 501c, 501d representing individual user interactions with individual applications. Alternatively, database 500 can include data structures associated with individual users, where the data structures associated with individual users include data sub-structures associated with a particular user's interaction with a given application. Any data organization system that allows data to be stored and accessed according to individual interactions with specific applications is within the scope of the invention.

Each data structure, e.g., 501d, contains a unique identifier 504, which allows the data structure 501d to be queried by the GUI rendering module 207. The unique identifier optionally includes the login ID of an individual user and an identification of the application for which that user's preferences are stored. Data structure 501d contains one more tasks 502 that have been defined by the task compiler 206 described above with reference to FIG. 2. Each task 502 contains a task weight 503. Task weight 503 is a parameter that represents the desirability of maintaining the current definition of the associated task 502. A low task weight value indicates that a task is not frequently used because, for example, it has been poorly defined by the task compiler 206. A high task weight value indicates that a task is used frequently. Task weight 502 may be set manually or automatically. For example, when the task compiler 206 identifies a task, embodiments of the invention query the user to determine whether, in the future, the user would like to see the individual actions grouped by the task compiler 206 aggregated into a task. If the user answers “yes”, the task weight 502 is set with some non-zero value indicating a well-defined task. Additionally, or alternatively, the task weight 502 is defined automatically through continued user interaction with the task. For example, if a task is defined as presenting two “wizards” to a user sequentially, a user's performing the steps prompted by those wizards in sequence would increase the task weight 502. Alternatively, if the user closed out of one of the wizards before completing the task, which might indicate that the task was poorly defined, the task weight 503 would be decreased. Embodiments according to the invention could delete a task 502, with or without first prompting the user, in the event that the task weight fell below some pre-defined threshold. Additionally, or alternatively, embodiments of the invention can automatically decrease the task weight 503 value over the time that a task is not used.

Data structure 501d contains display preferences 505. Display preferences 505 includes records generated by both the user display preferences tracking module 211 and the information view tracking module 209 described above with reference to FIG. 2. As is set forth above, display preferences include information regarding changes that the user makes to the default GUI generated by an application, for example, changes to background colors, fonts or manually defining the position of links to various tasks and/or actions. Display preferences 505 also includes an ordered list of tasks defined by the task compiler 206 and an ordered list of stand-alone information views generated by the information view tracking module 209. The lists of tasks and views are ordered according to the frequency with which a user accesses specific tasks or calls up specific views. Tasks that are frequently launched are given a higher rank than tasks that are used infrequently. Information views that are frequently accessed are given a higher rank than views that are accessed less frequently. The GUI rendering module 207 uses display preferences 505 to prominently display tasks and/or information views that have high rank, for example, by displaying links to those tasks and/or information views high on the screen or with larger or bolded icons. The various sub-parts included in display preferences 505 can be stored as a single data structure or as multiple data structures included in or accessible by data structure 501d.

Data structure 501d includes an error repository 506. Error repository 506 contains the record of error messages generated by the error message tracking module 211 described above with reference to FIG. 2. Error repository 506 includes information on the frequency with which users receive particular error messages from the application.

Information regarding the frequency with which error messages are received by particular users running particular applications can be used to generate customized GUIs that reduce error frequency. For example, embodiments according to the invention can present error messages generated by the application with certain text presented more prominently, for example, in bold. Alternatively, custom error messages could be generated by an administrator and substituted for the default error messages. Such manually customized error messages or alternations to default error messages would be accessible by the GUI rendering module 207.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to configure a graphical user interface (“GUI”), comprising:
executing a first executable code to generate a first GUI;
detecting a user interaction with said first GUI;
identifying a current action based upon said user interaction;
associating a present time with said current action;
identifying a previous action associated with a previous time;
calculating an actual time interval comprising the time interval between said current time and said previous time;
providing a threshold time interval associate with said previous action; and
determining if said actual time interval is greater than said threshold time interval.

2. The method of claim 1, further comprising:
if said actual time interval is not greater than said threshold time interval, defining a task to comprise said current action and said previous action;
if said time interval is greater than said threshold time interval, defining said task to comprise said current action and said previous action.

3. The method of claim 2, further comprising:
providing a user repository;
generating instructions related to said task; and
storing said instructions in said user repository.

4. The method of claim 2, further comprising associating said task with a specific user.

5. The method of claim 4, further comprising:
generating data regarding the association of said task with said specific user; and
storing said data in said user repository.

6. The method of claim 2, further comprising:
forming a second executable code, wherein said second executable code when executed generates a second GUI, wherein said second GUI comprises one or more interactive graphical objects related to said task.

7. The method of claim 1, wherein identifying a current action based upon said user interaction comprises identifying a user idle period.

8. The method of claim 1, further including the step of accessing an historical task database.

9. The method of claim 8, wherein said threshold time interval is variable and said variable threshold time interval is defined automatically based on an identification of the current user action and information included in the historical task database.

10. A graphical user interface configuration system, comprising:
a first executable code which when executed generates a graphical user interface (“GUI”);
a user feedback tracking module in communication with said GUI, wherein said user feedback tracking module comprises logic to detect a current action associated with a user interaction with said GUI;
a user feedback analyzer in communication with said user feedback tracking module, said user feedback analyzer comprising logic to:
identify a type of action detected by said user feedback tracking module; and
generate an actual time associated with said current action;
a threshold temporal value; and
a task compiler in communication with said user feedback analyzer, wherein said task compiler compares said actual time with said threshold time value.

11. The graphical user interface configuration system of claim 10, wherein said task compiler comprises logic to define a task comprising a plurality of user interactions with a GUI that occur within a time interval defined by said threshold temporal value.

12. The graphical user interface configuration system of claim 11, further comprising:
a user preferences repository in communication with said task compiler;
wherein said user preferences repository comprises at least one user preference, the user preference comprising one or more of: a task, a preferred information view or display preferences.

13. The graphical user interface configuration system of claim 11, further comprising a GUI rendering module comprising logic to form a second executable code, wherein the second executable code when executed generates a second GUI comprising a graphical representation of said task.

14. The graphical user interface configuration system of claim 10, wherein said user feedback analyzer further comprises logic to identify a user idle period.

15. The graphical user interface configuration system of claim 10, further comprising an historical task database.

16. The graphical user interface configuration system of claim 15, wherein the threshold temporal value is variable and said variable threshold time interval is defined automatically based on an identification of the current user action and information included in the historical task database.

17. A computer program product embodied in a computer readable medium, said computer program product being useable with a processor to configure a graphical user interface, comprising:
computer readable program code which causes said programmable computer processor to execute first executable code to generate a first GUI;
computer readable program code which causes said programmable computer processor to detect a user interaction with said first GUI;
computer readable program code which causes said programmable computer processor to identify a current action based upon said user interaction;
computer readable program code which causes said programmable computer processor to associate a present time with said current action;
computer readable program code which causes said programmable computer processor to identify a previous action associated with a previous time;
computer readable program code which causes said programmable computer processor to calculate an actual time interval comprising the time interval between said current time and said previous time;
computer readable program code which causes said programmable computer processor to provide a threshold time interval associated with said previous action; and
computer readable program code which causes said programmable computer processor to determine if said actual time interval is greater than said threshold time interval.

18. The computer program product of claim 17, further comprising:
computer readable program code which, if said actual time interval is not greater than said threshold time interval, causes said programmable computer processor to define a task to comprise said previous action;
computer readable program code which, if said time interval is greater than said threshold time interval, causes said programmable computer processor to define said task to comprise said previous action but not said current action.

19. The computer program product of claim 18, further comprising:
computer readable program code which causes said programmable computer processor to generate instructions relating to said task; and
computer readable program code which causes said programmable computer processor to store said instructions in a user repository.

20. The computer program product of claim 19, further comprising computer readable program code which causes said programmable computer processor to associate said task with a specific user.

21. The computer program product of claim 18, further comprising
computer readable program code which causes said programmable computer processor to generate data regarding the association of said task with said specific user; and
computer readable program code which cases said programmable computer processor to store said data in said user repository.

22. The computer program product of claim 18, further comprising:
computer readable program code which causes said programmable computer processor to form second executable code, wherein said second executable code when executed generates a second GUI, wherein said second GUI comprises one or more interactive graphical objects related to said task.

23. The computer program product of claim 17, wherein the computer readable program code which causes said programmable computer processor to identify a current action based upon said user interaction identifies a user idle period.

24. The computer program product of claim 17, further comprising computer readable program code which causes said programmable computer processor to access an historical task database.

25. The computer program product of claim 24, wherein the variable threshold time interval is variable and wherein said variable threshold time interval is defined automatically based on an identification of the current user action and information included in an historical task database.

26. A computer readable medium encoding a data structure comprising information regarding user preferences to be used to render a GUI, the data structure comprising data regarding:
a task based upon historical user preferences;
display preferences based upon user interactions with a default GUI and information views selected by a user;
an error repository comprising one or more error messages received by a user; and
a unique identifier associating a task, display preferences, and an error repository with a specific user's interactions with a specific application generating a specific GUI.

27. The computer readable medium of claim 26, wherein the task is associated with a task weight indicating the desirability a current definition of a task.

28. A method to configure a graphical user interface (“GUI”), comprising:
executing a first executable code to generate a first GUI;
detecting a first user interaction with said first GUI;
identifying a first action based upon said first user interaction;
detecting a second user interaction with said first GUI;
identifying a second action based upon said first user interaction;
accessing an historical task database, wherein the historical task database comprises an historical record of previously identified actions that have previously been grouped into tasks; and
defining a task comprising said first action and said second action.

29. The method of claim 28, further comprising:
providing a user repository;
generating instructions related to said task; and
storing said instructions in said user repository.

30. The method of claim 29, further comprising associating said task with a specific user.

31. The method of claim 30, further comprising:
generating data regarding the association of said task with said specific user; and
storing said data in said user repository.

32. The method of claim 29, further comprising:
forming a second executable code, wherein said second executable code when executed generates a second GUI, wherein said second GUI comprises one or more interactive graphical objects related to said task.
